(19) United States
(12) Patent Application Publication
(10) Pub. No.: US 2026/0100992 A1
(43) Pub. Date: Apr. 9, 2026

(54) Generative Artificial Infrastructure

(71) Applicant: Dell Products L.P., Round Rock, TX (US)

(72) Inventors: Michael Marrotte; Jason Liu, Wellesley, MA (US)

(21) Appl. No.: 18/907,127

(22) Filed: Oct. 4, 2024

(51) Int. Cl. H04L 67/63; H04L 69/18

(52) U.S. Cl. CPC H04L 67/63; H04L 69/18

(57) ABSTRACT

A system can receive a request from a requestor device to create computing infrastructure. The system can generate a response to the request that indicates that generating the computing infrastructure succeeded, independently of having generated the computing infrastructure. The system can store an association between the request and the response in a database. The system can send the response to the requestor device.

### BACKGROUND

A computer system can comprise multiple components.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a request from a requestor device to create computing infrastructure. The system can generate a response to the request that indicates that generating the computing infrastructure succeeded, independently of having generated the computing infrastructure. The system can store an association between the request and the response in a database. The system can send the response to the requestor device.

An example method can comprise generating, by a system comprising at least one processor, a response to a request to create computing infrastructure that indicates that generating the computing infrastructure succeeded, independently of having generated the computing infrastructure. The method can further comprise storing, by the system, an association between the request and the response in a data store. The method can further comprise sending, by the system, the response to a requestor device that originated the request.

An example non-transitory computer-readable medium can comprise instructions that, in response to execution, cause a system comprising a processor to perform operations. These operations can comprise generating a response to a request to create artificial computing infrastructure, independently of having generated computing infrastructure that corresponds to the artificial computing infrastructure. These operations can further comprise storing an association between the request and the response in a database. These operations can further comprise sending the response to a requestor that originated the request.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate generative artificial infrastructure, in accordance with an embodiment of this disclosure;

FIG. 2 illustrates another example system architecture that can facilitate generative artificial infrastructure, in accordance with an embodiment of this disclosure;

FIG. 3 illustrates an example signal flow that can facilitate generative artificial infrastructure, in accordance with an embodiment of this disclosure;

FIG. 4 illustrates example data that can facilitate generative artificial infrastructure, in accordance with an embodiment of this disclosure;

FIG. 5 illustrates more example data that can facilitate generative artificial infrastructure, in accordance with an embodiment of this disclosure;

FIG. 6 illustrates more example data that can facilitate generative artificial infrastructure, in accordance with an embodiment of this disclosure;

FIG. 7 illustrates an example process flow that can facilitate generative artificial infrastructure, in accordance with an embodiment of this disclosure;

FIG. 8 illustrates another example process flow that can facilitate generative artificial infrastructure, in accordance with an embodiment of this disclosure;

FIG. 9 illustrates another example process flow that can facilitate generative artificial infrastructure, in accordance with an embodiment of this disclosure; and

FIG. 10 illustrates an example block diagram of a computer operable to execute an embodiment of this disclosure.

### DETAILED DESCRIPTION

### Overview

Hardware and software infrastructure can be expensive. Even when virtualized or software-defined and in the cloud; deploying and running at-scale can have a problem of being cost prohibitive, which can stifle innovation.

To solve this problem, the present techniques can be implemented for generating artificial infrastructure—that is, infrastructure that does not exist, virtual or otherwise. This artificial infrastructure can comprise infrastructure metadata generated on-demand by artificial intelligence that provides an illusion that it exists.

For example, an application programming interface (API) response to provisioning or listing thousands of virtual machines can occur when those machines do not exist. This approach can extend to other types of infrastructure, including an operating system (OS).

In some examples, the present techniques can be implemented with a protocol multiplexer, protocol controllers, a collection of fine-tuned large language models, and a document database. In some examples, present techniques to generate the artificial infrastructure can leverage these components in a particular way as described herein.

The present techniques can facilitate utilizing a unique combination of system components (e.g., a protocol multiplexer, proxy controllers, one or more large language models, and a document database), which can interact with each other in such a way that provides a new result-artificial infrastructure. Moreover, the present techniques can be implemented to facilitate a universal artificial infrastructure system that is extensible and pluggable, potentially supporting any type of infrastructure.

Prior approaches include simulators for training programs, but they are limited in scope to specific and static education and static lab exercises (typically embedded) with no indication of a comprehensive, dynamic, and general-purpose approach, in contrast to the present techniques.

There are also prior approaches with regard to object storage simulators (e.g., static code) that implement parts of an object storage API. The approach to achieving this result in the prior approaches is drastically different from the approach used in the present techniques.

The present techniques can be implemented in a variety of embodiments, including an agent-based system, a recurrent learning module, real data and object storage, a graphical user interface (GUI) portal simulator), and an infrastructure assistant.

In some examples of the present techniques, rather than creating real infrastructure, output can be generated that is indistinguishable from output in scenarios in which real infrastructure is created. This output can be, for example, a cloud API request response, or a SSH response.

It can be that each transaction (e.g., a request to create infrastructure, and a corresponding response) can be stored, and then this stored transaction can be referenced upon subsequent transactions. Stored transactions can provide data used by AI/a LLM to reason about a current artificial state of artificial infrastructure, and to generate output to provide a next response.

An example use case of the present techniques can be as follows. A developer can be working on an infrastructure as code (IAC) project. One way to test code written for this project can be to run it and deploy all the corresponding infrastructure. There can be a cost associated with this, where spinning up resources can have a minimum amount of billing time (e.g., an hour). By implementing the present techniques to produce artificial infrastructure, this billing can be avoided.

In an example of the present techniques, a document database can keep track of a state of creating various artificial infrastructure (e.g., creating artificial virtual machines, and then making a subsequent request to them, such as shutting them down). It can be that a LLM lacks an inherent memory, and the document database maintains memory of transactions, such as in case a system that implements the present techniques is restarted, and those transactions would otherwise be lost.

### Example Architectures, Tables, and Flows

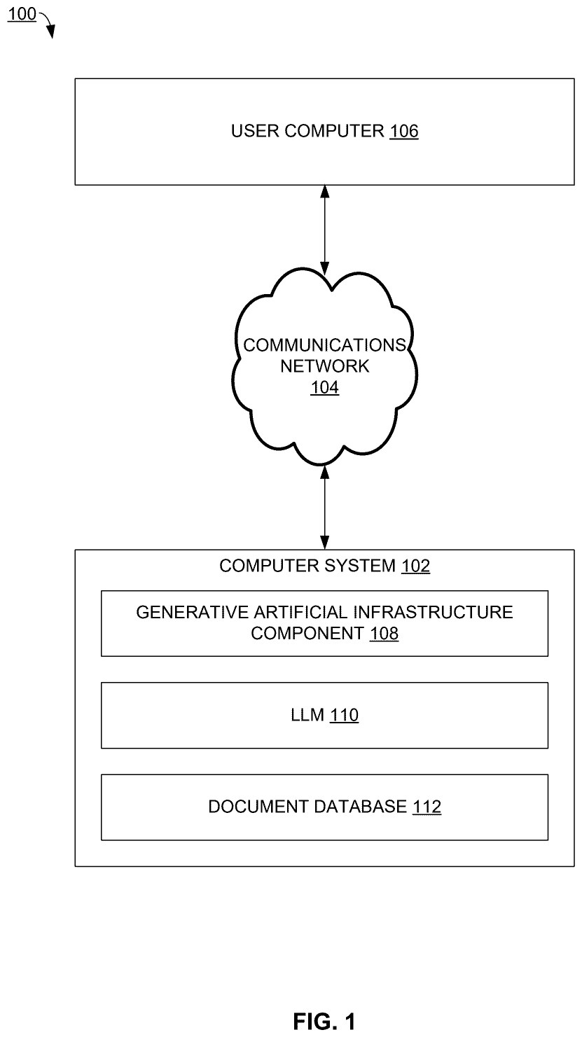

FIG. 1 illustrates an example system architecture 100 that can facilitate generative artificial infrastructure, in accordance with an embodiment of this disclosure.

System architecture 100 comprises computer system 102, communications network 104, and user computer 106. In turn, computer system 102 comprises generative artificial infrastructure component 108, LLM 110, and document database 112.

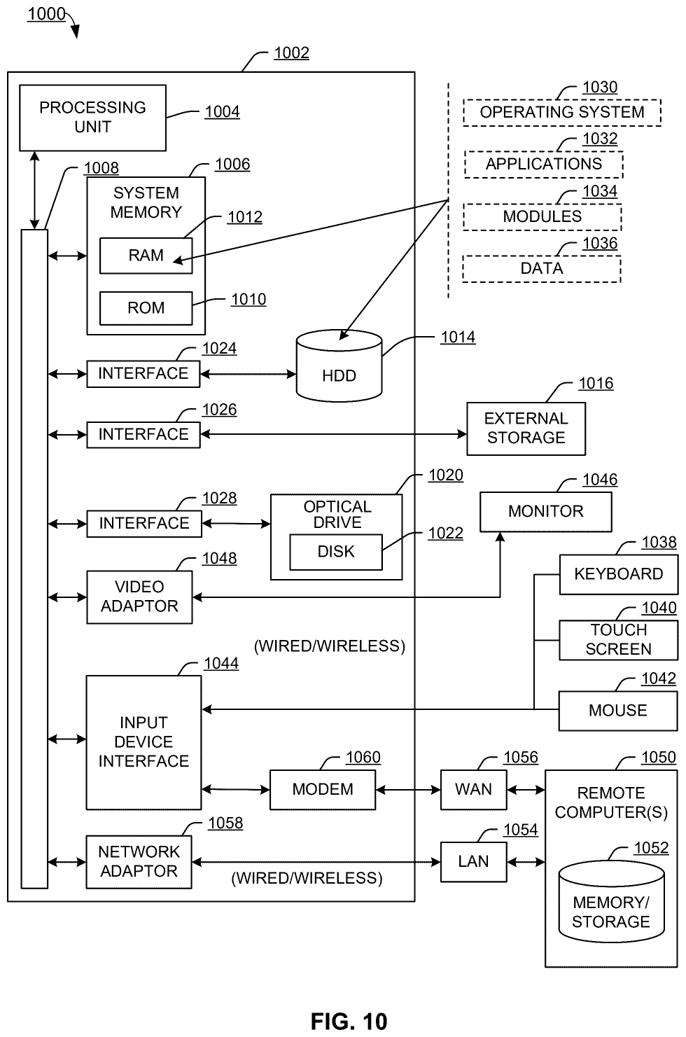

Each of computer system 102 and/or user computer 106 can be implemented with part(s) of computing environment 1000 of FIG. 10. Communications network 104 can comprise a computer communications network, such as the Internet, or an isolated private computer communications network.

User computer 106 can make a request to computer system 102—via communications network 104—to generate artificial infrastructure. This request can be processed by generative artificial infrastructure component 108, which can leverage LLM 110 to generate database storage commands to document database 112, as well as responses to user computer 106. Generative artificial infrastructure component 108 can leverage document database 112 to store pairs of requests and responses, to keep track of a state of the artificial infrastructure that has been generated (so that user computer 106 can make further requests to it, such as terminating artificial virtual machine instances that were previously created).

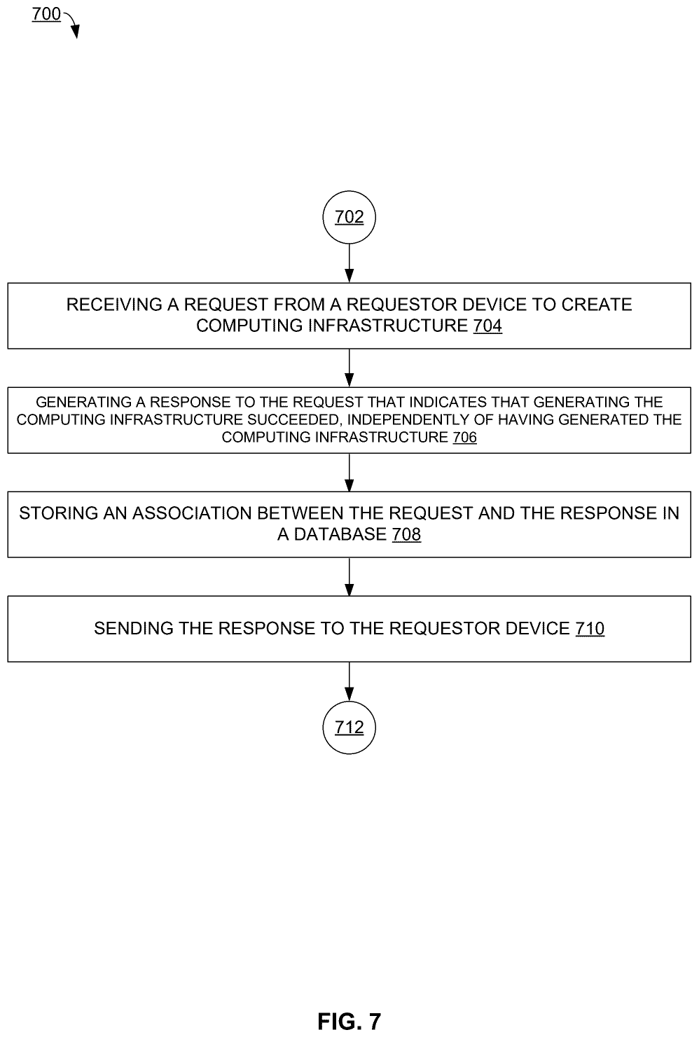

In some examples, generative artificial infrastructure component 108 can implement part(s) of the process flows of FIGS. 7-9 to facilitate generative artificial infrastructure.

It can be appreciated that system architecture 100 is one example system architecture for generative artificial infrastructure, and that there can be other system architectures that facilitate generative artificial infrastructure.

In general, a user can use an actual computer to interact with an artificial infrastructure system. The user could have an account on that computer. Then, there can be scenarios where there is a user account within the artificial infrastructure system—e.g., the system might or might not require user credentials depending on the type of the request. Creating a user account/user account credentials can be a valid request to the artificial infrastructure system, where the account/credentials can be considered on subsequent requests that utilize the newly created account/credentials.

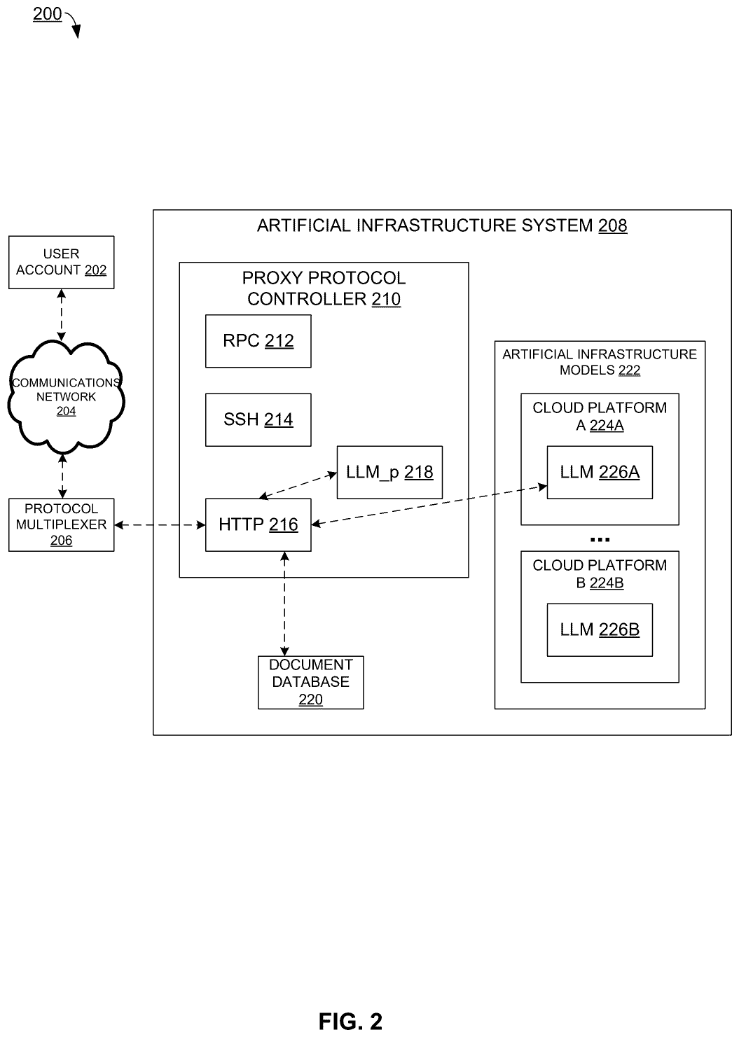

FIG. 2 illustrates another example system architecture 200 that can facilitate generative artificial infrastructure, in accordance with an embodiment of this disclosure. In some examples, part(s) of system architecture 200 can be implemented by part(s) of system architecture 100 of FIG. 1 to facilitate generative artificial infrastructure.

System architecture 200 comprises user account 202, communications network 204, protocol multiplexer 206, artificial infrastructure system 208, proxy protocol controller 210, remote procedure call (RPC) 212, secure shell (SSH) 214, hypertext transfer protocol (HTTP) 216, LLMₚ 218, document database 220, artificial infrastructure models 222, cloud platform A 224A, cloud platform B 224B, LLM 226A, and LLM 226B.

In system architecture 200, proxy techniques can be utilized to route real infrastructure requests from a user account to an artificial infrastructure system. For example, an artificial intelligence infrastructure service can be accessed with HTTP_PROXY, or a secure shell (ssh) service can be accessed with a ProxyCommand.

An artificial infrastructure system can comprise the following components:
Protocol Multiplexer: This can split traffic (raw data) at the network layer and send it to the appropriate proxy protocol controller handler, e.g., hypertext transfer protocol (HTTP), a SSH protocol, or a general packet radio service protocol (GPRS).
Proxy Protocol Controller: This can comprise pluggable and extensible component for handling various protocols like HTTP, SSH, and RPC. It can message various components such as its local large language model (LLMₚ) and the appropriate artificial infrastructure models' LLM, and perform database interaction.
Document Database: This can store, retrieve and update system input and output in a document database (e.g., a NoSQL database), leveraging dynamic schema, and formats like JavaScript Object Notation (JSON) and extensible Markup Language (XML).
Artificial Infrastructure Models: This can comprise a pluggable and extensible component for packaging and running large language models fine-tuned for specific infrastructure use cases, such as different cloud computing platforms from different vendors.

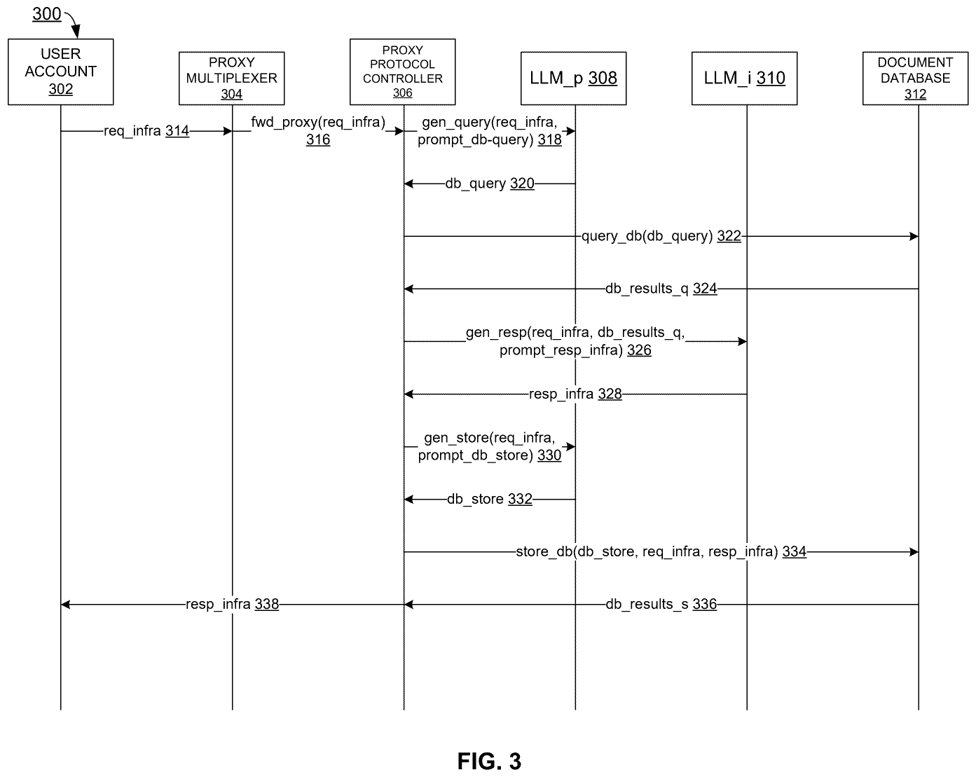

FIG. 3 illustrates an example signal flow 300 that can facilitate generative artificial infrastructure, in accordance with an embodiment of this disclosure. In some examples, part(s) of signal flow 300 can be implemented by part(s) of system architecture 100 of FIG. 1 to facilitate generative artificial infrastructure.

In signal flow 300, various signals are sent between user account 302, proxy multiplexer 304, proxy protocol controller 306, LLMₚ 308 (a LLM for proxy protocol controller 306), LLM; 310 (an artificial infrastructure LLM), and document database 312. These signals in signal flow 300 are:
request infrastructure 314 (req_infra);
forward the request to the proxy protocol controller 316 (fwd_proxy(req_infra));
generate a query based on req_infra and a prompt 318 (gen_query(req_infra, prompt_db-query));
database query 320 (db_query);
query the database with the query 322 (query_db(db_query));
query response 324 (db_results_q);
generate a response based on the request for infrastructure, the query response, and a prompt to request infrastructure 326 (gen_resp(req_infra, db_results_q, prompt_resp_infra));
infrastructure response 328 (resp_infra);
generate a database storage command 330 (gen_store(req_infra, prompt_db_store);
receive a database storage command 332 (db_store);
instruct the database to store the infrastructure request and response 334 (store_db(db_store, req_infra, resp_infra));
receive a result from the database 336 (db_results_s); and
send an infrastructure response 338 (resp_infra).

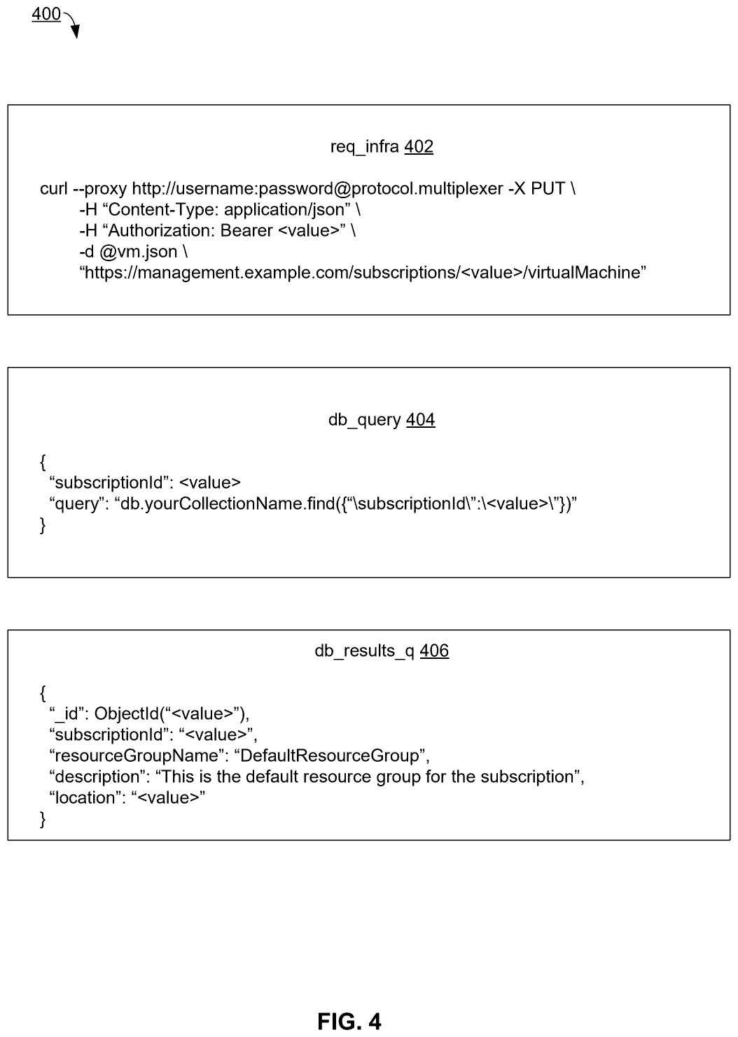

FIG. 4 illustrates example data 400 that can facilitate generative artificial infrastructure, in accordance with an embodiment of this disclosure. In some examples, part(s) of data 400 can be implemented by part(s) of system architecture 100 of FIG. 1 to facilitate generative artificial infrastructure.

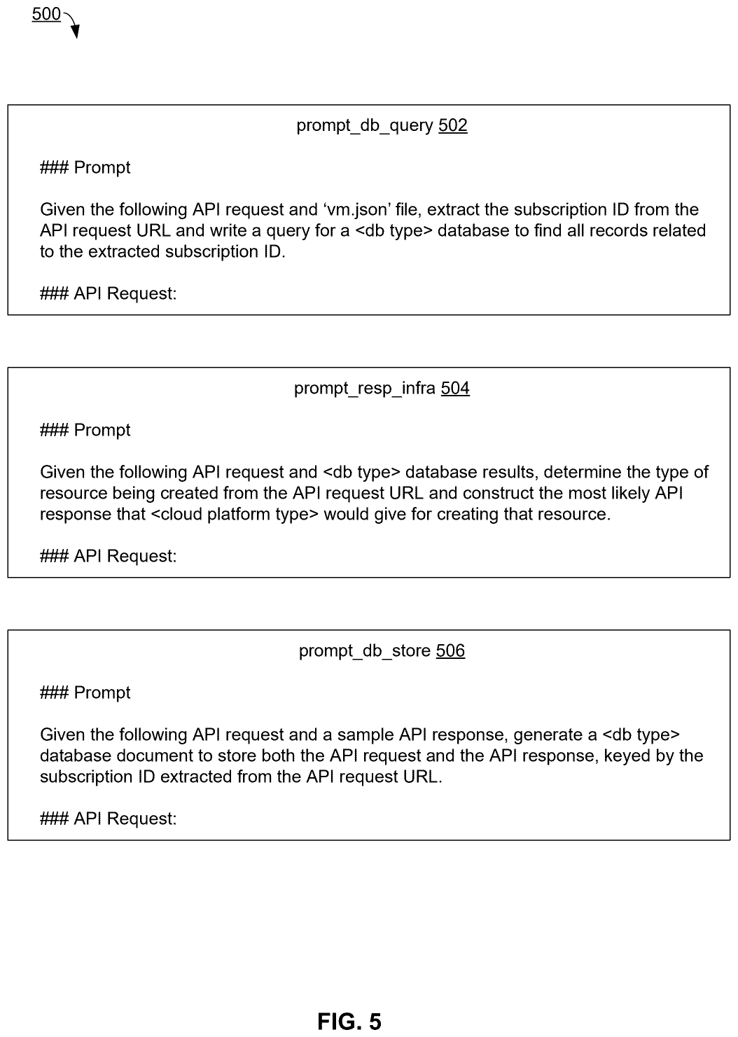

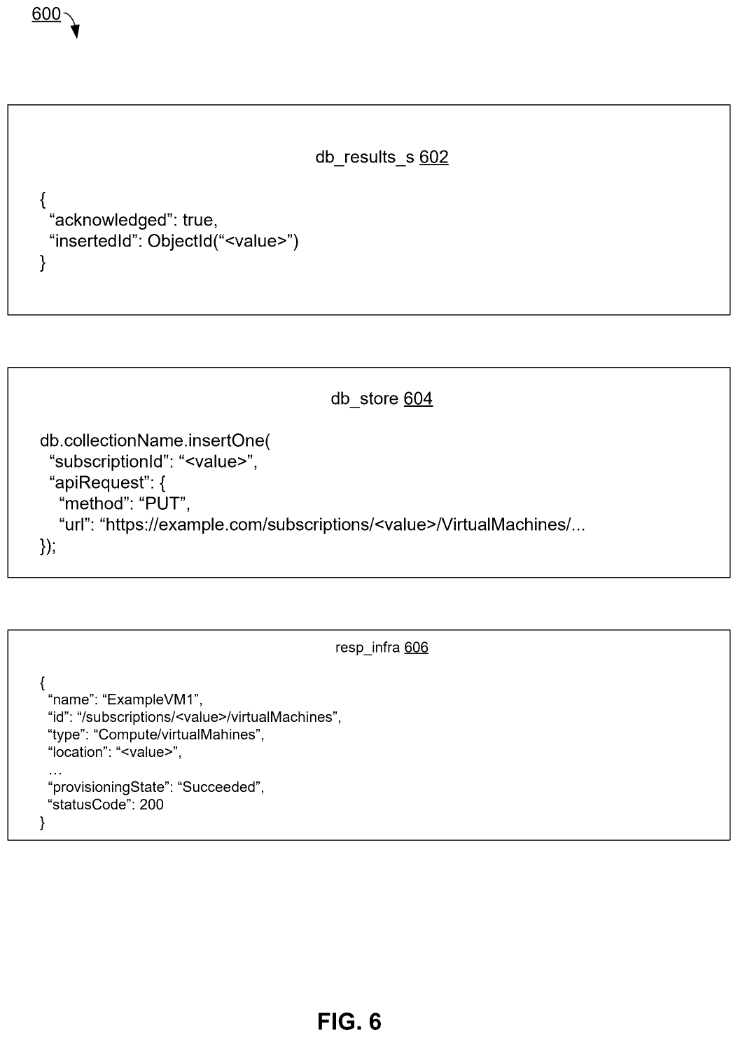

Data 400, data 500 of FIG. 5, and data 600 of FIG. 6 can comprise data that is transmitted in signal flow 300 (e.g., req_infra 402 can be used to make request infrastructure 314 of FIG. 3).

Data 400 comprises req_infra 402, db_query 404, and db_results_q 406.
Req_infra 402 depicts:
curl --proxy http://username:password@protocol.multiplexer -X PUT \

-H “Content-Type: application/json” \
-H “Authorization: Bearer <value>” \
-d @vm.json \

```
“https://management.example.com/subscriptions/<value>/virtualMachine”
Db_query 404 depicts:
{
  “subscriptionId”: <value>
  “query”: “db.yourCollectionName.find({“\subscriptionId\”:\<value>\”})”
}
Db_results_q 406 depicts:
{
  “_id”: ObjectId(“<value>”),
  “subscriptionId”: “<value>”,
  “resourceGroupName”: “DefaultResourceGroup”,
  “description”: “This is the default resource group for the subscription”,
  “location”: “<value>”
}
```

FIG. 5 illustrates more example data 500 that can facilitate generative artificial infrastructure, in accordance with an embodiment of this disclosure. In some examples, part(s) of data 500 can be implemented by part(s) of system architecture 100 of FIG. 1 to facilitate generative artificial infrastructure.

Data 500 comprises prompt_db_query 502, prompt_resp_infra 504, and prompt_db_store 506.

Prompt_db_query 502 depicts:
###Prompt
Given the following API request and ‘vm.json’ file, extract the subscription ID from the API request URL and write a query for a <db type> database to find all records related to the extracted subscription ID.
###API Request:
Prompt_resp_infra 504 depicts:
###Prompt
Given the following API request and <db type> database results, determine the type of resource being created from the API request URL and construct the most likely API response that <cloud platform type> would give for creating that resource.
###API Request:
Prompt_db_store 506 depicts:
###Prompt
Given the following API request and a sample API response, generate a <db type> database document to store both the API request and the API response, keyed by the subscription ID extracted from the API request URL.
###API Request:

FIG. 6 illustrates more example data 600 that can facilitate generative artificial infrastructure, in accordance with an embodiment of this disclosure. In some examples, part(s) of data 600 can be implemented by part(s) of system architecture 100 of FIG. 1 to facilitate generative artificial infrastructure.

```
Data 600 comprises db_results_s 602, db_store 604, and resp_infra 606.
Db_results_s 602 depicts:
{
  “acknowledged”: true,
  “insertedId”: ObjectId(“<value>”)
}
Db_store 604 depicts:
db.collectionName.insertOne(
  “subscriptionId”: “<value>”,
  “apiRequest”: {
  “method”: “PUT”,
  “url”: “https://example.com/subscriptions/<value>/VirtualMachines/...
});
Resp_infra 606 depicts:
{
  “name”: “ExampleVM1”,
  “id”: “/subscriptions/<value>/virtualMachines”,
  “type”: “Compute/virtualMahines”,
  “location”: “<value>”,
...
  “provisioningState”: “Succeeded”,
  “statusCode”: 200
}
```

### Example Process Flows

FIG. 7 illustrates an example process flow 700 that can facilitate generative artificial infrastructure, in accordance with an embodiment of this disclosure. In some examples, one or more embodiments of process flow 700 can be implemented by system architecture 100 of FIG. 1, or computing environment 1000 of FIG. 10.

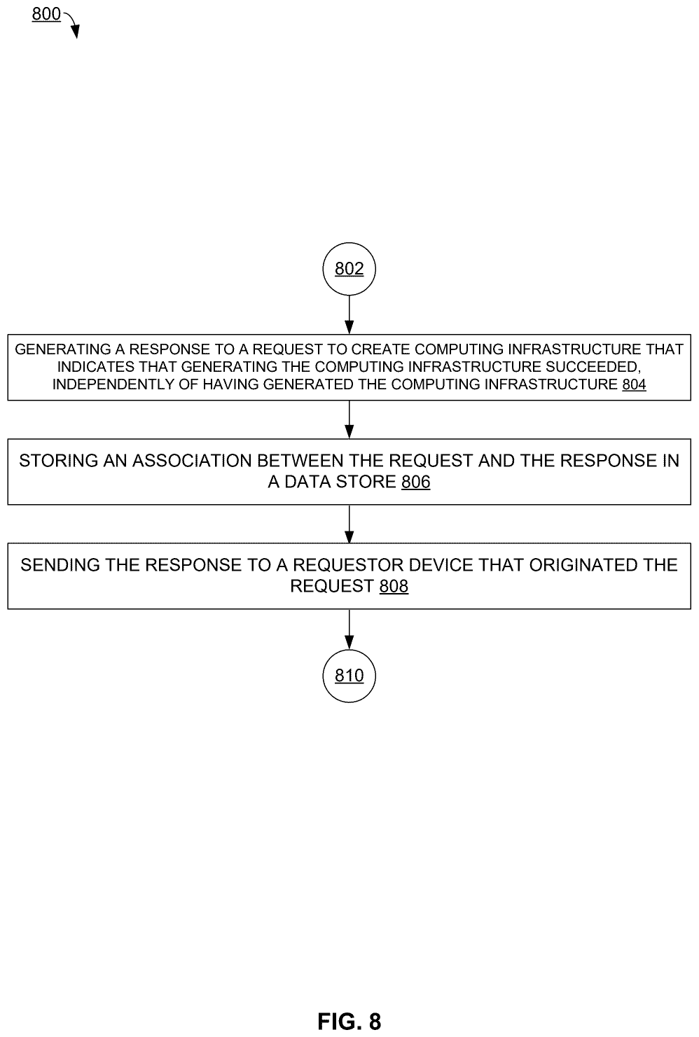

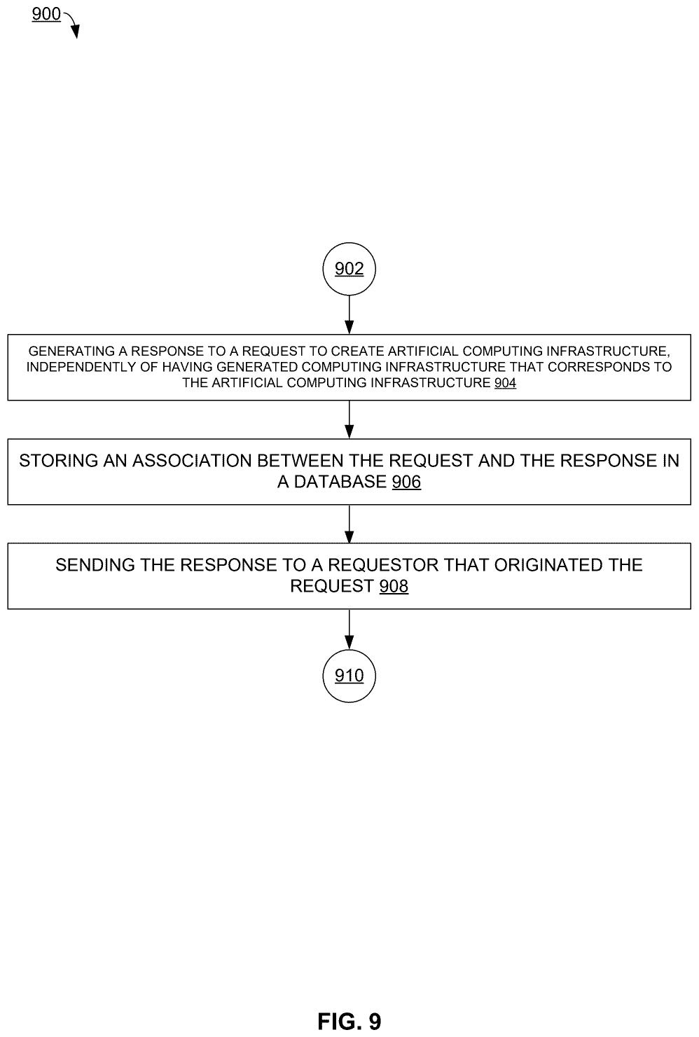

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 800 of FIG. 8, and/or process flow 900 of FIG. 9.

Process flow 700 begins with 702, and moves to operation 704.

Operation 704 depicts receiving a request from a requestor device to create computing infrastructure. This can comprise receiving a request to create infrastructure.

In some examples, network traffic comprises the request, and the request is received at a protocol multiplexer that is configured to split the network traffic at a network level. The protocol multiplexer can be similar to protocol multiplexer 206 of FIG. 2.

In some examples, a proxy protocol controller is configured to direct the request based on a protocol of the request. In some examples, the proxy protocol controller is configured to direct the request among a group of handlers, and wherein respective handlers of the group of handlers correspond to respective protocols. In some examples, the respective handlers comprise respective large language models that are tuned to process respective requests according to the respective protocols. In some examples, the protocol comprises a hypertext transfer protocol, a secure shell protocol, or a generative packet radio service protocol. This proxy protocol controller can be similar to proxy protocol controller 210 of FIG. 2.

In some examples, the request is targeted for a type of computing platform, and wherein the response is based on the type of the computing platform. In some examples, the type of the computing platform is a first type of a first computing platform, wherein a group of types of computing platforms comprises the first type of the first computing platform, and wherein the system is configured to generate respective responses based on respective types of the group of the types of the computing platforms. In some examples, there are a group of large language models, and wherein respective large language models of the group of large language models are configured to generate the respective responses.

That is, requests that are targeted to specific computing platforms can be targeted (e.g., where different platforms use different commands to perform a particular function). The present techniques can generate artificial infrastructure for different platforms. In some examples, different LLMs can be implemented, where different LLMs are tuned for different platforms (e.g., tuned to output commands recognized by that platform).

After operation 704, process flow 700 moves to operation 706.

Operation 706 depicts generating a response to the request that indicates that generating the computing infrastructure succeeded, independently of having generated the computing infrastructure. This can comprise creating a response to the request of operation 704 without having actually created the infrastructure. This can be done with an LLM.

After operation 706, process flow 700 moves to operation 708.

Operation 708 depicts storing an association between the request and the response in a database. The request and response can be stored together in a database, and accessed when processing future requests to preserve state (e.g., have knowledge of the artificial infrastructure previously generated).

After operation 708, process flow 700 moves to operation 710.

Operation 710 depicts sending the response to the requestor device. That is, the requestor can be told that infrastructure was actually created, even though it was artificial infrastructure that was created.

In some examples, the request is a first request, and operation 710 comprises processing a second request to utilize the computing infrastructure based on the association between the request and the response, and independently of having generated the computing infrastructure. That is, once the artificial infrastructure is generated, state can be stored in a document database (e.g., document database 220 of FIG. 2), and that state can be accessed to process new requests regarding that artificial infrastructure.

After operation 710, process flow 700 moves to 712, where process flow 700 ends.

FIG. 8 illustrates another example process flow 800 that can facilitate generative artificial infrastructure, in accordance with an embodiment of this disclosure. In some examples, one or more embodiments of process flow 800 can be implemented by system architecture 100 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 700 of FIG. 7, and/or process flow 900 of FIG. 9.

Process flow 800 begins with 802, and moves to operation 804.

Operation 804 depicts generating a response to a request to create computing infrastructure that indicates that generating the computing infrastructure succeeded, independently of having generated the computing infrastructure. In some examples, operation 804 can be implemented in a similar manner as operations 704-706 of FIG. 7.

After operation 804, process flow 800 moves to operation 806.

Operation 806 depicts storing an association between the request and the response in a data store. In some examples, operation 806 can be implemented in a similar manner as operation 708 of FIG. 7.

In some examples, the data store comprises a dynamic schema. In some examples, the association is stored in a javascript object notation format or an extensible markup language format. This data store can be similar to document database 220 of FIG. 2.

In some examples, the association is stored in the database with a key, wherein the key identifies a user account of a group of user accounts, and wherein the data store stores respective associations that correspond to respective user accounts of the user accounts. That is, the present techniques can implement one system to handle artificial infrastructure for multiple users, and the different artificial infrastructure for different users can be identified by using a key in database entries that identifies a user.

After operation 806, process flow 800 moves to operation 808.

Operation 808 depicts sending the response to a requestor device that originated the request. In some examples, operation 808 can be implemented in a similar manner as operation 710 of FIG. 7.

After operation 808, process flow 800 moves to 810, where process flow 800 ends.

FIG. 9 illustrates another example process flow 900 that can facilitate generative artificial infrastructure, in accordance with an embodiment of this disclosure. In some examples, one or more embodiments of process flow 900 can be implemented by system architecture 100 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 700 of FIG. 7, and/or process flow 800 of FIG. 8.

Process flow 900 begins with 902, and moves to operation 904.

Operation 904 depicts generating a response to a request to create artificial computing infrastructure, independently of having generated computing infrastructure that corresponds to the artificial computing infrastructure. In some examples, operation 904 can be implemented in a similar manner as operations 704-706 of FIG. 7.

In some examples, operation 904 depicts exposing an application programming interface to the requestor, wherein the request adheres to a format of the application programming interface, and wherein the response adheres to the format of the application programming interface.

In some examples, the request comprises a flag that indicates that the request is to generate artificial infrastructure. In some examples, the request is a first request, wherein the artificial computing infrastructure is first artificial computing infrastructure, and wherein a second request that omits the flag is processed to generate second computing infrastructure. That is, a flag can be made in a request to identify whether the request is to create artificial infrastructure, or to create actual infrastructure.

After operation 904, process flow 900 moves to operation 906.

Operation 906 depicts storing an association between the request and the response in a database. In some examples, operation 906 can be implemented in a similar manner as operation 708 of FIG. 7.

In some examples, the generating of the response and the storing of the association correspond to generating artificial infrastructure that corresponds to the artificial computing infrastructure. In some examples, the artificial infrastructure excludes virtualized infrastructure. That is, artificial infrastructure can be different from virtualized infrastructure (e.g., virtual machine instances).

After operation 906, process flow 900 moves to operation 908.

Operation 908 depicts sending the response to a requestor that originated the request. In some examples, operation 908 can be implemented in a similar manner as operation 710 of FIG. 7.

After operation 908, process flow 900 moves to 910, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102 and/or user computer 106 of FIG. 1.

In some examples, computing environment 1000 can implement one or more embodiments of the process flows of FIGS. 7-9 to facilitate generative artificial infrastructure.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1016 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving a request from a requestor device to create computing infrastructure;
generating a response to the request that indicates that generating the computing infrastructure succeeded, independently of having generated the computing infrastructure;
storing an association between the request and the response in a database; and
sending the response to the requestor device.

2. The system of claim 1, wherein network traffic comprises the request, and wherein the request is received at a protocol multiplexer that is configured to split the network traffic at a network level.

3. The system of claim 1, wherein a proxy protocol controller is configured to direct the request based on a protocol of the request.

4. The system of claim 3, wherein the proxy protocol controller is configured to direct the request among a group of handlers, and wherein respective handlers of the group of handlers correspond to respective protocols.

5. The system of claim 4, wherein the respective handlers comprise respective large language models that are tuned to process respective requests according to the respective protocols.

6. The system of claim 3, wherein the protocol comprises a hypertext transfer protocol, a secure shell protocol, or a generative packet radio service protocol.

7. The system of claim 1, wherein the request is targeted for a type of computing platform, and wherein the response is based on the type of the computing platform.

8. The system of claim 7, wherein the type of the computing platform is a first type of a first computing platform, wherein a group of types of computing platforms comprises the first type of the first computing platform, and wherein the system is configured to generate respective responses based on respective types of the group of the types of the computing platforms.

9. The system of claim 8, wherein the system comprises a group of large language models, and wherein respective large language models of the group of large language models are configured to generate the respective responses.

10. The system of claim 1, wherein the request is a first request, and wherein the operations further comprise:
processing a second request to utilize the computing infrastructure based on the association between the request and the response, and independently of having generated the computing infrastructure.

11. A method, comprising:
generating, by a system comprising at least one processor, a response to a request to create computing infrastructure that indicates that generating the computing infrastructure succeeded, independently of having generated the computing infrastructure;
storing, by the system, an association between the request and the response in a data store; and
sending, by the system, the response to a requestor device that originated the request.

12. The method of claim 11, wherein the data store comprises a dynamic schema.

13. The method of claim 11, wherein the association is stored in a javascript object notation format or an extensible markup language format.

14. The method of claim 11, wherein the association is stored in the database with a key, wherein the key identifies a user account of a group of user accounts, and wherein the data store stores respective associations that correspond to respective user accounts of the user accounts.

15. A non-transitory computer-readable medium comprising instructions that, in response to execution, cause a system comprising at least one processor to perform operations, comprising:
generating a response to a request to create artificial computing infrastructure, independently of having generated computing infrastructure that corresponds to the artificial computing infrastructure;
storing an association between the request and the response in a database; and
sending the response to a requestor that originated the request.

16. The non-transitory computer-readable medium of claim 15, wherein the operations further comprise:
exposing an application programming interface to the requestor, wherein the request adheres to a format of the application programming interface, and wherein the response adheres to the format of the application programming interface.

17. The non-transitory computer-readable medium of claim 15, wherein the request comprises a flag that indicates that the request is to generate artificial infrastructure.

18. The non-transitory computer-readable medium of claim 17, wherein the request is a first request, wherein the artificial computing infrastructure is first artificial computing infrastructure, and wherein a second request that omits the flag is processed to generate second computing infrastructure.

19. The non-transitory computer-readable medium of claim 15, wherein the generating of the response and the storing of the association correspond to generating artificial infrastructure that corresponds to the artificial computing infrastructure.

20. The non-transitory computer-readable medium of claim 19, wherein the artificial infrastructure excludes virtualized infrastructure.
